(19) United States
(12) Patent Application Publication
(10) Pub. No.: US 2018/0231040 A1
(43) Pub. Date: Aug. 16, 2018

(54) SOCKET PIPE CONNECTION AND SALES TABLE WITH AT LEAST ONE SOCKET PIPE CONNECTION

(71) Applicant: WANZL METALLWARENFABRIK GMBH, Lipheim (DE)

(72) Inventors: Thomas SAUTER, Bubesheim (DE); Alexis WOLF, Senden (DE)

(73) Assignee: WANZL METALLWARENFABRIK GMBH, Lipheim (DE)

(21) Appl. No.: 15/506,994

(22) PCT Filed: Jun. 3, 2015
(86) PCT No.: PCT/EP2015/062366

§ 371 Date: Feb. 27, 2017

(30) Foreign Application Priority Data
Sep. 1, 2014 (DE) 10 2014 112 542.8

(51) Int. Cl. F16B 7/22; F16B 12/32; F16L 47/12

(52) U.S. Cl. CPC F16B 7/22; E04B 1/5831; F16L 47/12; F16B 12/32

(57) ABSTRACT

A socket pipe connection includes at least one first tube and at least one second tube, wherein the first tube has a recess into which the second tube can be inserted, wherein the second tube has at least one slot by means of which the second tube can be slid onto an edge of the recess, wherein the recess is blocked by an elastic blocking element in the installed state. The socket pipe connection can be used on a sales table with at least one socket pipe connection.

The present invention relates to a socket pipe connection as well as a sales table with at least one socket pipe connection.

Sales tables for self-service stores are used for the presentation and the sale of goods and are already known from the current versions of the technology.

These sales tables are frequently converted and should therefore be easy to assemble and dismantle. In addition, the sales tables must also be comparatively stable and able to withstand heavy weight loads.

A sales table with a base frame which has four feet is already known from WO 2007/068454 A1. The sales table further comprises four side frames which are arranged parallel and each have a wall, as well as a floor which is arranged above the base frame and is delimited by the walls.

The DE 20 2004 018 815 U1 reveals a socket pipe connection comprising of at least one first pipe and at least one second pipe, the first pipe having a recess into which the second pipe can be inserted. The second pipe has a slot with which the second pipe can be pushed onto an edge of the recess.

The WO 2010/012928 A2 reveals a sales table with a socket pipe connection, wherein a rigid metal catch with a receiving slot for a plug-on socket is provided in a first pipe. The plug-on socket is inserted into the metal bar through a recess in the first pipe. A second pipe is then placed on the plug-on socket.

The object of the present invention is to further develop a socket pipe connection as well as a sales table with at least one socket pipe connection of the initially mentioned type in an advantageous manner, in particular so that tat the latter can be more easily assembled and mounted.

This objective is achieved according to the invention by a socket pipe connection with the features of claim 1. A socket pipe connection includes of at least one first pipe and at least one second pipe, the first pipe having a recess into which the second pipe can be inserted, whereby the second pipe has at least one slot with which the second pipe can be pushed onto an edge of the recess, the recess being blocked in the assembled state by an elastic blocking element.

The invention is based on the basic idea that the socket pipe connection can be installed by merely plugging in the elements of the socket pipe connection, namely the first pipe, the second pipe and the elastic blocking element. Tool-free assembly is thus possible. The socket pipe connection may comprise of only the first pipe, the second pipe, and the elastic blocking element. In order to fix the second pipe in the first pipe, it is inserted or pushed into the first pipe. There, it is then displaced in the recess such that the slot of the second pipe is slipped onto an edge of the recess in the first pipe. The elastic element is then inserted into the recess, thereby preventing decoupling from the first pipe and the second pipe.

The elastic blocking element also serves to dampen and prevent rattling noises.

It is conceivable that the first pipe and the second pipe are square pipes.

Furthermore, the first pipe can be given a larger outer diameter than the second pipe. Here, in particular the inner diameter of the first pipe can be made larger than the outer diameter of the second pipe. This has the advantage that the end of the second pipe to be inserted into the first pipe through the recess can be accommodated completely in the first pipe.

It is particularly advantageous if the inner diameter of the first pipe and the outer diameter of the second pipe form a fit. This because in this case, the second pipe is restricted by the first pipe with respect to its possibilities of making relative movement, and the stability of the socket pipe connection is improved.

Suitable materials for the pipes are steel, galvanized steel, stainless steel, aluminum or similar.

The recess can be arranged in an outer surface of the pipe, in particular when the first pipe is a square pipe. It is also conceivable for the recess also to extend to at least one further outer surface.

The elastic blocking element can be inserted into the recess so it can be released. In particular, the elastic blocking element can be inserted detachably into the recess in the mounted state. In addition to a simple assembly, this also enables a simple disassembly, namely through simple loosening and removing the elastic blocking element from the recess. As a result, the second pipe can be displaced in the recess such that it can be pulled out of the recess and thus out of the first pipe.

In particular, the elastic blocking element can be provided as a plastic component.

It is, in particular, conceivable that the elasticity of the blocking element results from the shaping of the blocking element.

The blocking element can in particular be a plastic clip.

The elastic blocking element can, for example, be an extruded plastic profile. This plastic profile can be cut to length according to the dimensions of the recess. In principle, however, it is also conceivable that the blocking element is designed as a plastic injection-molded part.

In addition to the recess, at least one clip opening can be provided in the first pipe. In particular, the clip opening can be arranged adjacent to the recess. Alternatively, or additionally, it is also possible for the clip opening to be intended for receiving a clip portion of the blocking element. Easy locking of the blocking element is possible by simply clipping. Furthermore, with a dismantling operation, the blocking element can be pushed out of the clip opening and thereby be released. The blocking element can substantially completely cover and/or fill the recess in the assembled state. The advantage thereby is that the second pipe is blocked and fixed in the recess by the blocking element in the assembled state, i.e. in the state inserted into the first pipe. A movement of the first pipe and the second pipe relative to one another is effectively prevented. This serves not least to minimize noise, but also the stability of the socket pipe connection.

The blocking element can have at least one essentially C-shaped spring section. This shaping provides a stable and at the same time elastic structure due to the shaping. In particular, two substantially C-shaped spring sections can be provided.

Furthermore, the blocking element can be provided with at least one connecting shoulder for abutment against a part of the edge of the recess. The blocking element can be unambiguously positioned in the recess, for example by the fact that, when the blocking element is inserted into the recess, the shoulder abutment strikes against a part of the edge of the recess and can no longer be pushed or inserted further into the recess.

The slot in the second pipe may be C-shaped. This shape allows stable fixing of the first pipe relative to the second pipe. Moreover, this shaping allows sufficient overlapping of the portion of the edge of the recess to which the second pipe is slipped with the slot.

Furthermore, provision can be made for the slot to extend over the entire width of an outer surface of the second pipe and over a respective part of two further outer surfaces. This makes it possible to attach the second pipe stably and uniformly to the part of the edge of the recess onto which the second pipe is attached with the slot so that this connection can also be used as a load-bearing connection. It is conceivable in this context that the second pipe carries the first pipe and the force introduction of the weight force of the first pipe and the load additionally absorbed by the first pipe is absorbed in the region of the slit through the second pipe and transferred into the second pipe.

The recess can extend over the entire width of an outer surface of the first pipe and over a part of two further outer surfaces each. This facilitates insertion of the second pipe into the first pipe, but also insertion of the blocking element into the recess.

Furthermore, the present invention relates to a sales table. A sales table according to the invention has at least one socket pipe connection as described above.

The sales table can have a lower frame. The lower frame may be furnished with rollers. The lower frame can, for example, have two main struts, which in turn are interconnected by transverse struts.

The connection of a transverse strut to a main strut may be formed by a socket pipe connection as described above. It is conceivable in this context that the main strut forms the first pipe of the socket pipe connection and the transverse strut forms the second pipe of the socket pipe connection. The reverse arrangement is also possible.

One or more rollers or supporting feet may be attached to the transverse struts.

Furthermore, the sales table can have an upper frame, which has four vertical struts in relation to the erected state.

Each vertical strut may be connected to a main strut of the lower frame by means of a socket pipe connection as described above.

It is conceivable in this connection that the vertical strut forms the first pipe of the socket pipe connection and the main strut of the lower frame lower pipe forms the second pipe of the socket pipe connection. The reverse arrangement is also possible in principle.

The four vertical struts of the upper frame can extend beyond the socket pipe connection in the erected condition in the direction of the floor or the installation surface but do not touch these. Rather, the entire sales table can only be placed on the rollers or supporting feet attached to the lower frame. The total weight of the sales table and the goods placed thereon is then transmitted to the socket pipe connection between the vertical struts and the main struts of the lower frame via the four vertical struts. The socket pipe connection is in each case arranged in such a way that the blocking element is below the main strut in the erected state so that the force transmission takes place only from the vertical strut (first pipe) to the main strut (second pipe) in the region of the slot and does not load the blocking element. The blocking element thus serves only as a safety device for the socket pipe connection, but is not a load-bearing element of the socket pipe connection.

If the lower frame has no rollers or feet, the total weight of the sales table and the goods placed thereon is supported by the four vertical struts of the upper frame.

The upper frame can support a sales basket. The sales basket can have several walls, which are formed by wire bar grates.

Further details and benefits of the invention will now be explained in more detail by means of a design example illustrated in the drawings.

It shows:

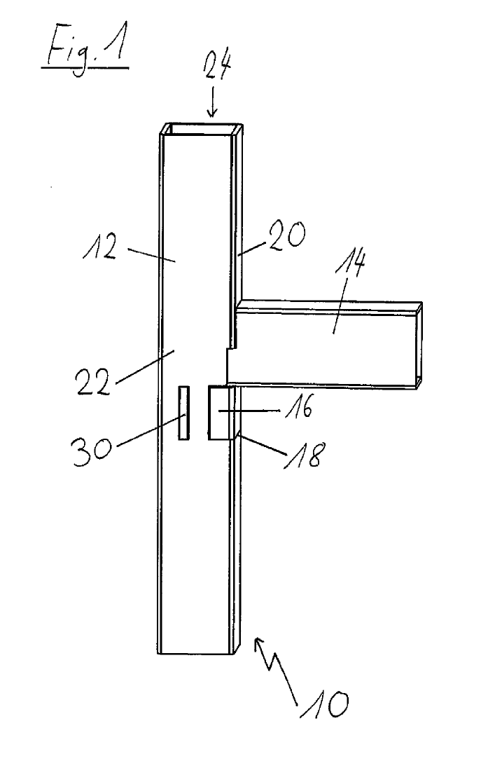

FIG. 1 shows a perspective view of a design example of a socket pipe connection according to the invention;

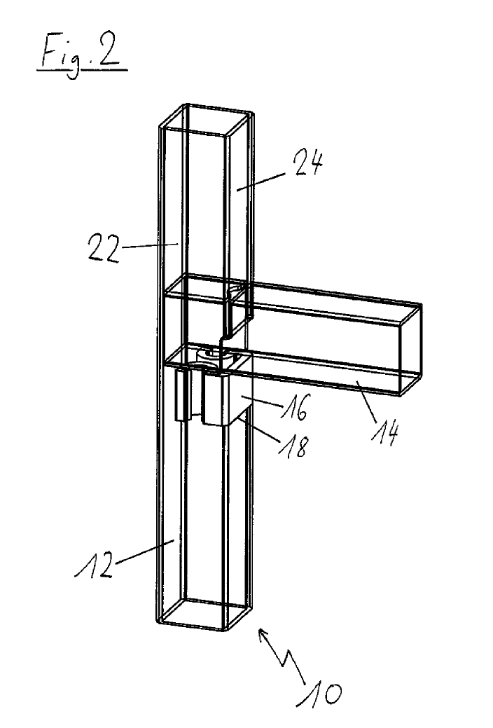

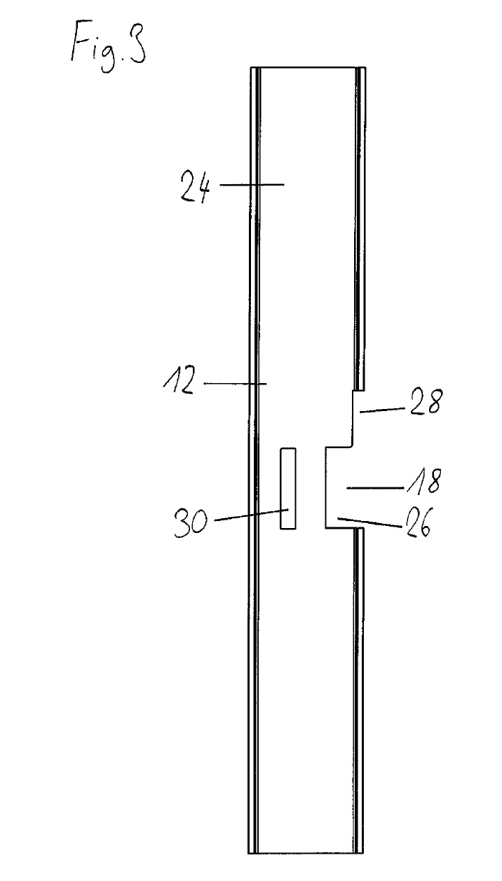

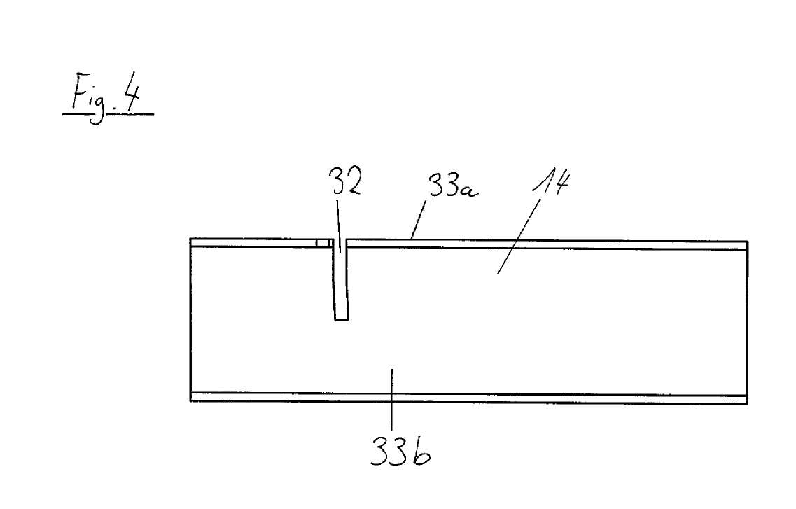

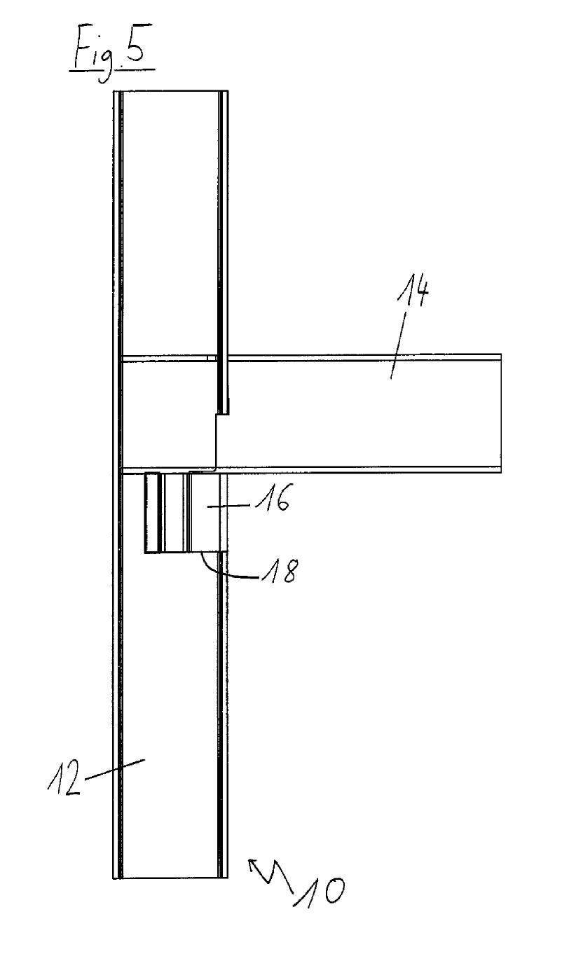

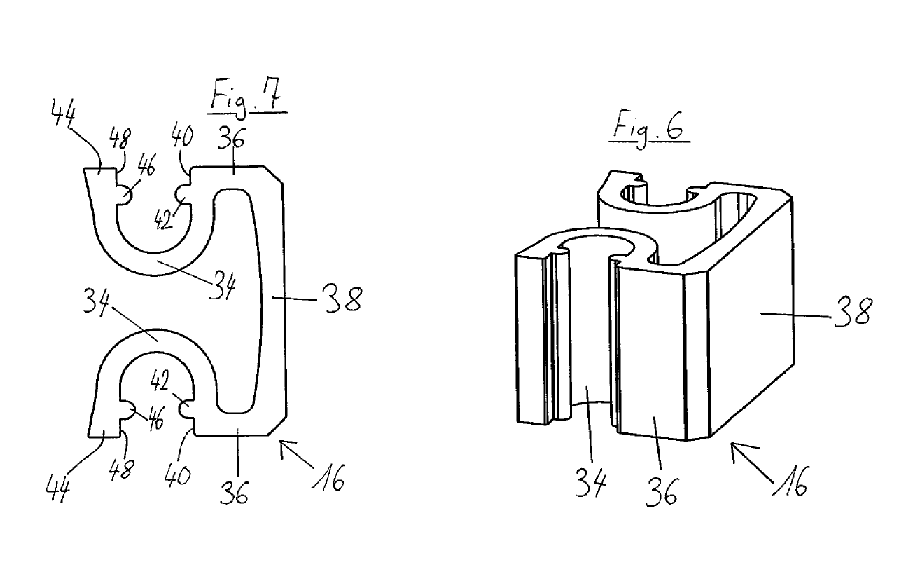

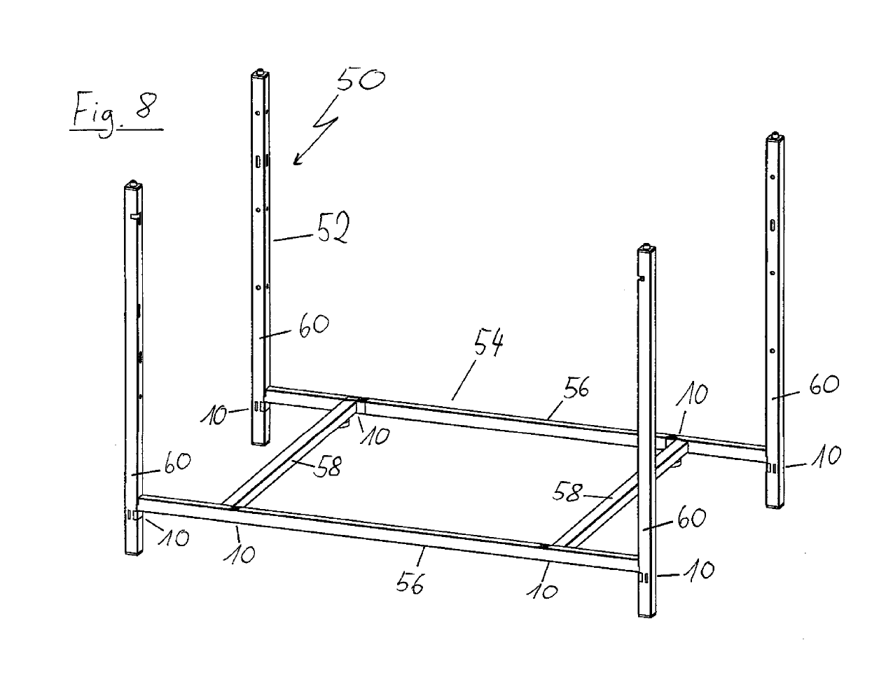

FIG. 2 shows a further perspective view of the socket pipe connection according to FIG. 1;

FIG. 3 is a sectional view of a first pipe of the socket pipe connection according to FIG. 1;

FIG. 4 shows a sectional view of a second tube of the socket pipe connection according to FIG. 1;

FIG. 5 shows a sectional view of the socket pipe connection according to FIG. 1;

FIG. 6 shows a perspective view of an elastic blocking element of the socket pipe connection according to FIG. 1;

FIG. 7 shows a front view of the elastic blocking element according to FIG. 6;

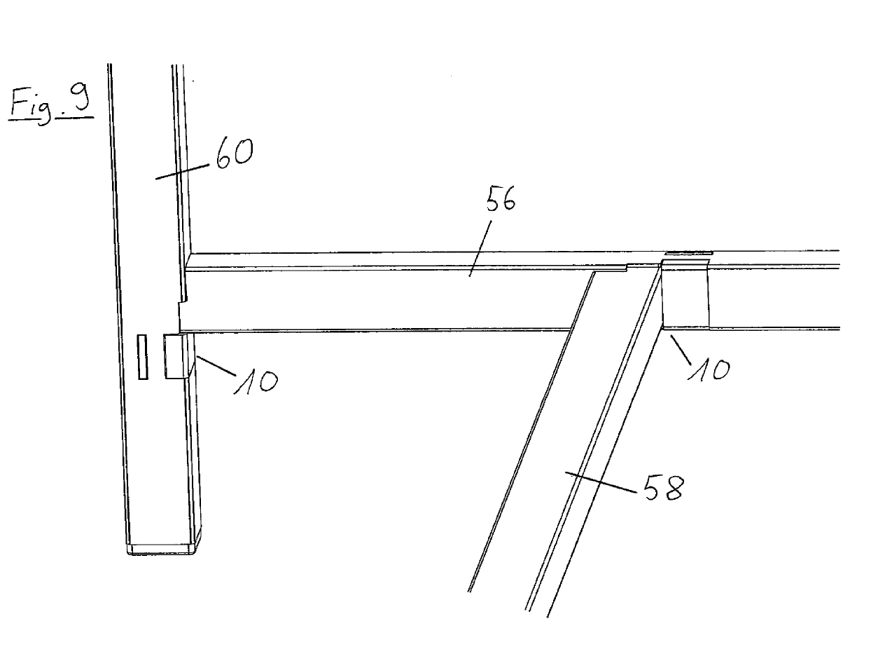

FIG. 8 shows a perspective view of the upper frame and lower frame of a design example of a sales table according to the invention;

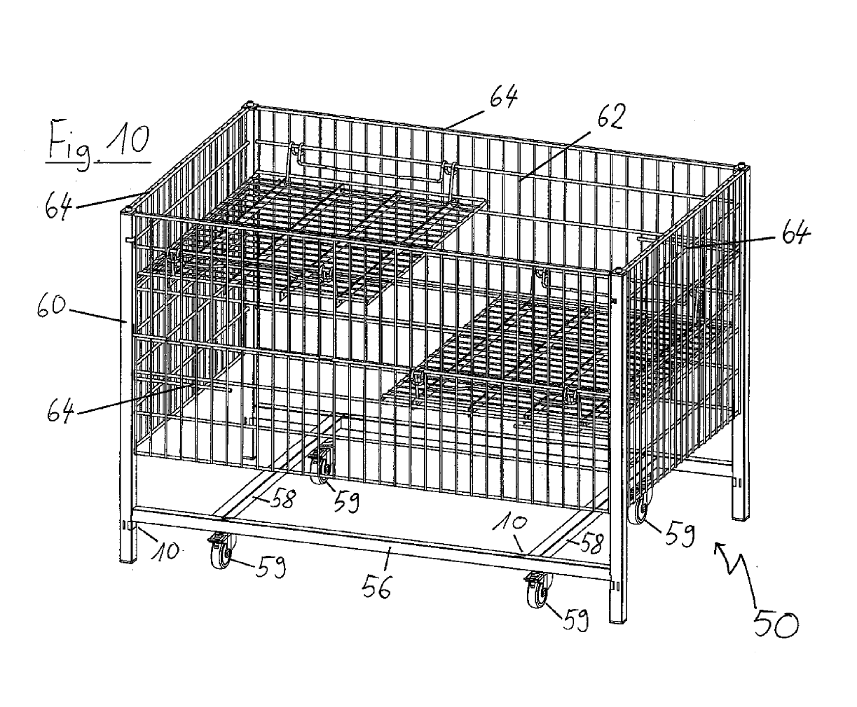

FIG. 9 shows a detailed view of the upper frame and lower frame of a design example of a sales table as per the invention according to FIG. 8;

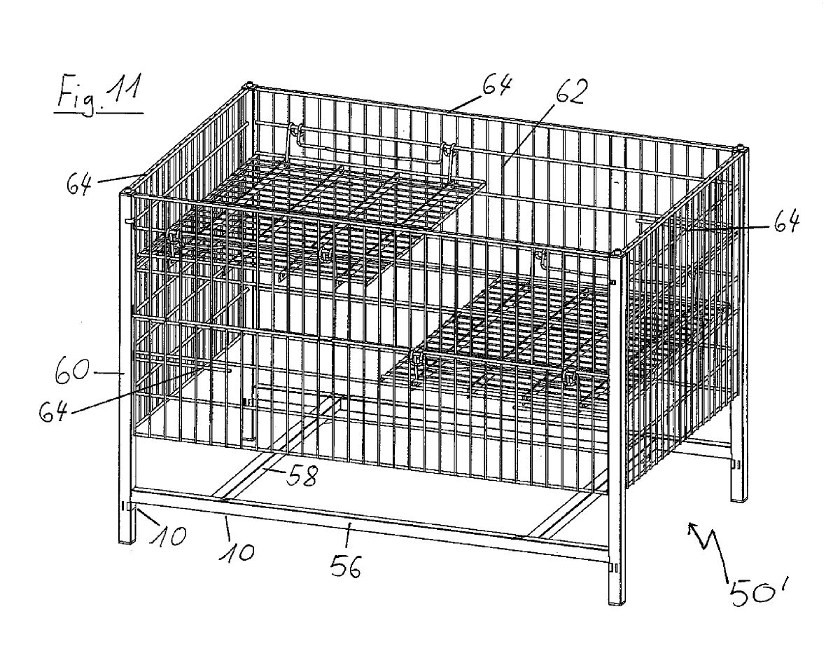

FIG. 10 shows a perspective view of a design example of a sales table according to the invention; and

FIG. 11 shows a perspective view of a further design example of a sales table according to the invention.

FIG. 1 shows a perspective view of a design example of a socket pipe connection according to the invention 10.

The socket pipe connection 10 comprises at least one first pipe 12 and at least one second pipe 14.

In addition, the socket pipe connection 10 comprises at least one elastic blocking element 16.

The first pipe 12 and the second pipe 14 are each square pipes of galvanized steel. In principle, the square pipes can be made of steel, stainless steel, aluminum or similar.

The inner diameter of the first pipe 12 is larger than the outer diameter of the second pipe 14.

The inner diameter of the first pipe 12 and the outer diameter of the second pipe 14 are selected here to form a fit (see also FIG. 2).

As can be seen in FIGS. 1 and 2, the second pipe 14 is inserted into the first pipe 12 through a recess 18.

The recess 18 is arranged in an outer surface 20 of the first pipe 12, namely the outer surface 20 facing the second pipe 14, and extends there over the entire width of the outer surface 20.

The height of the recess 18 essentially corresponds to the height of the second pipe 14 and is dimensioned in such a way that the pipe end of the second pipe 14 to be inserted into the first pipe 12 can be pushed completely into the recess 18.

The recess 18 also extends to the outer surfaces 22, 24 adjacent to the outer surface 20.

FIG. 3 shows the side view of the first pipe 12 in which the silhouette of the recess 18 is visible in the outer surface 24, i.e., an outer surface of the first pipe 12 into which the second pipe 14 is not inserted. The recess 18 is formed in the outer surface 24 in the same way as in the outer surface 22, and is essentially L-shaped. In this area, the outer surface 24 has a first area 26 which extends deeper into the outer surface 24 and which is intended for receiving the blocking element 16 (see also FIG. 1 and FIG. 2).

The second area 28 is the area in which the second pipe 14 is in the inserted or fully assembled state.

Adjacent to the first region 26 of the recess 18, a rectangular clip opening 30 is provided in the outer surface 24. A clip opening 30 of this type is also provided at a corresponding location in the outer surface 22.

The second pipe 14, as shown in FIG. 4, has a slot 32. The slot 32 is C-shaped.

The slot 32 extends over the entire width of an outer surface 33a of the second pipe 14 and over a part of each of the outer surfaces 33b adjoining this outer surface 33a, namely over half the width of the adjacent outer surfaces 33b.

FIG. 5 shows that, in the installed state, the slot 32 is pushed onto the edge of the recess 18 in the outer surface 20, specifically in the second area 28 of the recess 18.

In the assembled state, the elastic blocking element 16 is detachably inserted into the recess 18, specifically in the area 26 of the recess 18.

The elastic blocking element 16 is designed here as a plastic clip, see also FIG. 6 and FIG. 7.

The elasticity of the blocking element 16 results from the shaping of the blocking element 16.

In the design element shown, the elastic blocking element 16 is an extruded plastic profile.

In principle, however, it is also conceivable that the blocking element 16 is designed as a plastic injection-molded part.

The blocking element 16 has two substantially C-shaped spring sections 34. This shaping provides a stable and at the same time elastic structure due to the shaping.

The two spring sections 34 are each mounted on a side wall 36 of the blocking element 16. The two side walls 36 are in turn connected to the back 38 of the blocking element 16.

In the assembled state of the socket pipe connection 10, the two side walls 36 and the back 38 of the blocking element 16 fill the first region 26 of the recess 18, see in particular FIGS. 1, 2 and 5.

As shown in FIG. 6 and FIG. 7, each blocking element 16 has a shoulder abutment 40 for abutment against a part of the edge of the recess 18.

Each shoulder abutment 40 is delimited by a rounded limiting strip 42 which is also provided for abutment against a part of the edge of the recess 18. The limiting strip 42 delimits the shoulder abutment 40 in such a way that the width of the shoulder abutment 40 substantially corresponds to the thickness of the pipe sheeting of the first pipe 12.

The free ends of the spring portions 34 form rectangular clip-on sections 44 for insertion into the rectangular clip openings 30. Also, here, a rounded limiting strip 46 is provided, which delimits the clip attachment shoulder abutment 48 of the clip-on section 44.

The limiting strip 46 delimits the clip-on attachment shoulder abutment 48 in such a way that the width of the clip-on attachment shoulder abutment 48 essentially corresponds to the thickness of the pipe sheeting of the first pipe 12.

In the mounted state, the second pipe fills the second area 28 and the remaining free area 26 of the recess 18 is completely covered and filled by the blocking element 16. The area 26 is outwardly filled and covered by the side walls 36 and the back 38 of the blocking element 16.

FIG. 8 shows a perspective view of an upper frame 52 and a lower frame 54 of a design example of a sales table 50, according to the invention, which has several socket pipe connections 10 as described above.

The lower frame 54 has two main struts 56, which in turn are interconnected by transverse struts 58.

The connection of a transverse strut 58 to a main strut 56 is formed by a socket pipe connection 10 as described above. The main strut 56 forms the first pipe of the socket pipe connection 10 and the transverse strut 58 the second pipe of the socket pipe connection 10. The reverse arrangement is also possible in principle.

One or more rollers 59 (refer FIG. 10) or supporting feet may be attached to the transverse struts 58.

The upper frame 52 has four vertical struts 60 relative to the erected state.

Each vertical strut 60 is connected to a main strut 56 of the lower frame 54 by means of a socket pipe connection 10 as described above.

The vertical strut 60 is the first pipe of the socket pipe connection 10 and the main strut 56 of the lower frame 54 is the second pipe of the socket pipe connection 10.

The four vertical struts 60 of the upper frame 52 can extend beyond the socket pipe connection 10 in the erected state in the direction of the floor or the installation surface but do not touch the latter. Rather, the entire sales table 50 can only be placed on the rollers 59 or supporting feet which are fastened to the lower frame 54.

The upper frame 52 supports a sales basket 62. The sales basket 62 has several walls 64, which are formed by wire bar grates (see FIG. 10 and FIG. 11).

FIG. 9 shows a detailed view of the upper frame 52 and the lower frame 54 of a design example of a sales table 50 according to FIG. 8.

FIG. 10 shows a perspective view of a design example of a sales table 50 with rollers 59, according to the invention.

FIG. 11 shows a perspective view of a further design example of a sales table 50 according to the invention in which the sales table 50 stands on the vertical struts 60.

The assembly and the function of the socket pipe connection 10 can be described as follows:

The second pipe 14 is inserted into the first pipe 12 for the assembly of the socket pipe connection 10 and is pressed with the slot 32 onto the edge of the recess 18 in the outer surface 20, which faces the second pipe 14 in the installed state, into area 28.

The C-shape of the slot 32 allows a stable fixation of the first pipe 12 relative to the second pipe 14. In addition, this shaping allows sufficient overlapping of the portion of the edge of the recess 18 on which the second tube 14 with the slot 32 is placed.

This makes it possible to place the second pipe 14 stably and uniformly on the part of the edge of the recess 18, on which the second pipe 14 with the slot 32 is inserted, so that this connection can also be used as a load-bearing connection. As shown, for example, in FIG. 10 and FIG. 11, it is provided for the socket pipe connection 10 between the upper frame 52 and the lower frame 54, that is, the connections of the four vertical struts 60 of the upper frame 52 with the main struts 56 of the lower frame 54, that the second pipe, i.e. the main strut 56 carries the first pipe, i.e. the vertical strut 60, and the force introduction of the weight force of the first pipe and the load additionally absorbed by the first pipe is received in the region of the slot by the second pipe and introduced into the second pipe.

The total weight of the sales table 50 and the goods placed thereon is then transmitted to the socket pipe connection 10 between the vertical struts 60 and the main struts 56 of the lower frame 54 via the four vertical struts 60. The socket pipe connection 10 is arranged in each case in such a way that the blocking element 16 is located below the main strut 56 in the erected state so that the force transmission takes place only from the vertical strut 60 (first pipe) onto the main strut 56 (second pipe) in the area of the slot 32 of the main strut 56 and the blocking element 16 is not loaded. The blocking element 16 thus serves only as a securing means for the socket pipe connection 10, but is not a supporting element of this socket pipe connection 10.

If the lower frame 54 does not have rollers 59 or supporting feet, the entire weight of the sales table 50 and the goods placed thereon is carried by the four vertical struts 60 of the upper frame 52.

Due to the fit between the inner diameter of the first pipe 12 and the outer diameter of the second pipe 14, the relative movements of the second pipe 14 are restricted by the first pipe 12, and the stability of the socket pipe connection 10 is improved.

After the second pipe 14 has been inserted into the first pipe 12, it is fixed in the recess 18 by the elastic blocking element 16.

The elastic blocking element 16 also serves to dampen and prevent rattling noises.

The elastic blocking element 16 is detachably pressed into the recess 18 and detachably clipped into the clip-on openings 30 with the clip portions 44. In addition to a simple assembly, this also makes simple disassembly possible, namely by simply loosening and removing the elastic blocking element 16 from the recess 18. As a result, the second pipe 14 can then be moved again in the recess 18 so that it can be pulled out of the recess 18 and thus out of the first pipe 12.

A simple locking of the blocking element 16 is made possible by the clip-in of the clip section 44 of the blocking element 16 into the clip opening 30. Moreover, during disassembly the blocking element 16 can be simply pushed out of the clip openings 30 and thereby released.

The blocking element 16 is uniquely positioned in the recess 18, by the fact that when the locking element 16 is inserted into the recess 18 of the shoulder abutment 40, the shoulder abutment 40 strikes a part of the edge of the recess 18 and, due to the shape, can no longer be pushed or inserted further into the recess.

The advantage of the fact that the blocking element 16 substantially covers and fills the recess 18 in the assembled state is that the second pipe 14 is blocked and fixed by the blocking element 16 in the recess 18 in assembled state, i.e. when inserted into the first pipe 12. A relative movement of the first pipe 12 and the second pipe 14 relative to one another is effectively prevented. This serves not least to reduce the noise, but also for the stability of the socket pipe connection 10.

1. A socket pipe connection comprising:
at least one first pipe,
at least one second pipe,
whereby the first pipe has a recess,
and the first pipe and the second pipe are configured such that the second pipe can be inserted into the recess,
the second pipe has at least one slot which is configured such that the one slot can be pushed onto an edge of the recess,
an elastic blocking element configured to be releasably inserted into the recess to block the removal of the second pipe,
at least one clip opening is provided in the first pipe for receiving a clip portion of the blocking element, and
wherein the blocking element includes at least one substantially C-shaped spring section.

2. (canceled)

3. (canceled)

4. Socket pipe connection according to claim 3, wherein the clip opening is arranged adjacent to the recess.

5. (canceled)

6. Socket pipe connection according to claim 1, wherein the locking element substantially completely covers and/or fills the recess in the assembled state.

7. Socket pipe connection according to claim 1, wherein the blocking element two essentially C-shaped spring sections.

8. Socket pipe connection according to claim 1, wherein the blocking element has at least one shoulder abutment for abutment against a part of the edge of the recess.

9. Socket pipe connection according to claim 1, wherein the slot is C-shaped.

10. Socket pipe connection according to claim 1, wherein the slot extends over the entire width of an outer surface of the second pipe and over a part of each of two further outer surfaces.

11. Socket pipe connection according to claim 1, wherein the recess extends over the entire width of an outer surface of the first pipe and over a part of each of two further outer surfaces.

12. A sales table having at least one socket pipe connection according to claim 1.
